(19) United States
(12) Patent Application Publication
(10) Pub. No.: US 2016/0222225 A1
(43) Pub. Date: Aug. 4, 2016

(54) Fire Resistant Coating Formulation

(71) Applicant: James Eugene Moseley, Marina Del Rey, CA (US)

(72) Inventor: James Eugene Moseley, Marina Del Rey, CA (US)

(21) Appl. No.: 15/015,821

(22) Filed: Feb. 4, 2016

Related U.S. Application Data
(60) Provisional application No. 62/111,751, filed on Feb. 4, 2015.

(51) Int. Cl. C09D 5/18; C09D 7/12

(52) U.S. Cl. CPC C09D 5/18; C09D 7/1216; C09D 7/1233

(57) ABSTRACT

A fire prevention coating formula is applied to surfaces in order to reduce and prevent the spread of fires across the applied surfaces. The fire prevention coating formula includes a quantity of propane, a quantity of butane, a quantity of toluene, a quantity of ethylbenzene, a quantity of xylene, a quantity of trimethylbenzene, a quantity of acetone, a quantity of silica, a quantity of zirconia, and a quantity of inconel alloys, which are combined into a homogeneous coating mixture. The homogeneous coating mixture is applied to surfaces through spraying or painting means.

The current application claims a priority to the U.S. Provisional Patent application Ser. No. 62/111,751 filed on Feb. 04, 2015.

### FIELD OF THE INVENTION

The present invention relates generally to a formula that is used to prevent the spread of flames and smoke caused by fires. More specifically, it is a formula that can be applied to prevent the spread of flames and smoke on all surfaces.

### BACKGROUND OF THE INVENTION

While fire can be implemented as a useful tool, fire can be very destructive force of nature. Fire is the cause for the destruction of numerous homes and personal affects, as well as, cause people serious injuries and even death. Current means of fireproofing are only effective to certain levels of heat and flame exposure; however, with the advancement of heat shielding for space crafts, space crafts are able to withstand extreme aerodynamic heating which results from re-entering the Earth's atmosphere. The present invention incorporates

The present invention is a fire prevention coating formula to be applied to surfaces in order to prevent and discourage the spread of fire. The fire prevention coating formulation is able to bond to wood, plastics, metals. The present invention assists in lowering the amount of smoke and flames produced from fires. Therefore, the present invention reduces and possibly eliminates the spread of fire.

### DETAIL DESCRIPTIONS OF THE INVENTION

All illustrations of the drawings are for the purpose of describing selected versions of the present invention and are not intended to limit the scope of the present invention.

The present invention is a fire prevention coating formulation. The present invention is applied to surfaces in order to reduce or eliminate the spread of fire across the surface. Applicable surfaces for the present invention include, but are not limited to most metals, wood, stucco, and plastics. The present invention penetrates into the surface in order to impart fire resistant properties to the surface.

The present invention comprises a quantity of propane, a quantity of butane, a quantity of toluene, a quantity of ethylbenzene, a quantity of xylene, a quantity of trimethylbenzene, a quantity of acetone, a quantity of silica, a quantity of zirconia, and a quantity of inconel alloys. The quantity of propane, the quantity of butane, the quantity of toluene, the quantity of ethylbenzene, the quantity of xylene, the quantity of trimethylbenzene, the quantity of acetone, the quantity of silica, the quantity of zirconia, and the quantity of inconel alloys is combined into a homogeneous coating mixture. The homogeneous coating mixture dries clear after being applied to a surface. The homogeneous coating mixture assists in reducing the amount of smoke from the combustion reaction of the surface and lowers the rate of combustion across the surface to reduce the rate which flames spread.

The homogeneous coating mixture is applied to surfaces through traditional painting or spraying methods. The homogeneous coating mixture is preferred to be distributed evenly across the surface to impart consistent fire prevention properties across the surface. Specific applications of the present invention include, but are not limited to, houses, cars, playgrounds, or furniture.

Although the invention has been explained in relation to its preferred embodiment, it is to be understood that many other possible modifications and variations can be made without departing from the spirit and scope of the invention as hereinafter claimed.

What is claimed is:

1. A fire resistant coating formulation comprises:
a quantity of propane;
a quantity of butane;
a quantity of toluene;
a quantity of ethylbenzene;
a quantity of xylene;
a quantity of trimethylbenzene;
a quantity of acetone;
a quantity of silica;
a quantity of zirconia;
a quantity of inconel alloys; and
the quantity of propane, the quantity of butane, the quantity of toluene, the quantity of ethylbenzene, the quantity of xylene, the quantity of trimethylbenzene, the quantity of acetone, the quantity of silica, the quantity of zirconia, and the quantity of inconel alloys being combined into a homogenous coating mixture.
